(19) United States
(12) Patent Application Publication
(10) Pub. No.: US 2014/0316997 A1
(43) Pub. Date: Oct. 23, 2014

(54) SYSTEMS AND METHODS FOR THE DYNAMIC PRESENTATION OF QUESTIONS AND/OR PROMPTS

(71) Applicant: LEVEL 3 COMMUNICATIONS, LLC, Broomfield, CO (US)

(72) Inventors: Thomas F. Van Buskirk, Arvada, CO (US); Stephen A. Ziele, Superior, CO (US); Charles C. Williams, Centennial, CO (US); Krista Louise Milholm, Lakewood, CO (US); Robert Andrew McCarroll, Denver, CO (US)

(73) Assignee: Level 3 Communications, LLC, Broomfield, CO (US)

(21) Appl. No.: 13/865,023

(22) Filed: Apr. 17, 2013

(51) Int. Cl. G06Q 30/00

(52) U.S. Cl. CPC G06Q 30/016
USPC 705/304

(57) ABSTRACT

Aspects of the present disclosure describe systems and methods for generating and presenting providing one or more questions and/or prompts to a customers that enable the customer to identify, diagnose, and/or resolve any technical problems the customer may currently be facing. Administrators may provide input to an interface, such as a graphical user interface (“GUI”), to automatically develop, arrange, group, and/or generate the series of questions/prompts provided to the customer. Other interfaces may be generated to receive input corresponding to the questions from other users and react to the input received from such users with appropriate responses or further questions.

### CROSS REFERENCE TO RELATED APPLICATION

The present non-provisional utility application claims priority under 35 U.S.C. §119(e) to co-pending provisional application No. 61/635,174 entitled “Methods And Systems For Dynamic Ticketing,” filed on Apr. 18, 2012, and which is hereby incorporated by reference herein.

### TECHNICAL FIELD

Aspects of the present disclosure relate to methods and systems for accessing and receiving customer information, and in particular, analyzing the customer information to generate one or more questions for display.

### BACKGROUND

With the advent of wired and wireless networking, the communications industry has been transformed from mainly providing telephone services to providing numerous network services and providing the infrastructure to handle such services. The unprecedented demand for high-speed network services has thus transformed the communications industry. Moreover, communications service providers are constantly offering upgraded or new communications products and services to customers. Among the services provided are high-speed Internet access services, collaboration and cloud computing services, content delivery and distribution services, and voice over internet protocol (VOIP) services. A customer, such as an Internet Television network provider, may, for example, obtain content delivery and distribution services from a communications services provider so that they can ensure their broadcast content is provided to users in a fast and efficient manner using the communication provider's network and services.

In addition to the communication providers offering such products and services to customers, it is necessary to provide the mechanisms to manage the customer's needs, such as by providing systems, applications, and/or software that enable customers to easily engage in customer support and/or other services. Conventional methods for providing customer support typically involve using proprietary systems of limited functionality or purchasing third party software capable of providing customer support. In either case, when a communications service provider seeks to offer dynamic support for new services or changes to services, or to offer customized support for a specific customers needs, the communications service provider must employ developers to add functionality to the system or modify existing functionality, both of which are time consuming and expensive.

It is with these concepts in mind, among others, that various aspects of the present disclosure were conceived and developed.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. It should be noted that the drawings are not necessarily to scale; however, the emphasis instead is being placed on illustrating the principles of the inventive concepts. Also, in the drawings the like reference characters refer to the same parts throughout the different views. The drawings depict only typical embodiments of the present disclosure and, therefore, are not to be considered limiting in scope.

FIG. 1 is a flow chart for generating questions and/or prompts, according to aspects of the present disclosure.

FIG. 2 is block diagram illustrating a computing environment for generating questions and/or prompts, according to aspects of the present disclosure.

FIG. 3 is a flow chart for displaying questions and/or prompts, according to aspects of the present disclosure.

FIG. 4A-4E is an example computing device for generating questions and/or prompts, according to aspects of the present disclosure.

FIGS. 5 illustrate a sequence of screen shots related to an example sequence of questions or prompts based upon a segment classification.

### SUMMARY

Aspects of the present disclosure include systems for generating and presenting questions. The system includes at least one processor. The processor is configured to generate a plurality of services. The plurality of services are configured to authenticate a user to obtain classification data, the classification data identifying a group of users for which at least one question may be displayed, the question stored in a data structure defining a hierarchical relationship between the question, a response, and at least one other question. The plurality of services are further configured to provide the at least one question to at least one user of the group of users for display.

Aspects of the present disclosure include methods for generating and presenting questions. The method includes generating, using at least one processor, a plurality of services to: authenticate a user to obtain classification data, the classification data identifying a group of users for which at least one question may be displayed, the question stored in a data structure defining a hierarchical relationship between the question, a response, and at least one other question. The method further includes providing the plurality of services to provide the at least one question to at least one user of the group of users for display.

Aspects of the present disclosure involve non-transitory computer-readable mediums for generating and presenting questions. The instructions, executable by a processor include generating a plurality of services. The plurality of services are configured to authenticate a user to obtain classification data, the classification data identifying a group of users for which at least one question may be displayed, the question stored in a data structure defining a hierarchical relationship between the question, a response, and at least one other question. The plurality of services are further configured to provide the at least one question to at least one user of the group of users for display.

### DETAILED DESCRIPTION

Aspects of the present disclosure extend to methods, systems, and computer program products for providing one or more questions and/or prompts to a customer that allow the customer to identify, diagnose, and/or resolve any technical problems the customer may currently be facing, and optionally submit notifications that should automatically initiate administrative action. More particularly, one or more interactive customer interfaces may be generated that enable the identification of a particular user, such as a customer, pose a series of questions to the identified user, receive input corresponding to the questions from the user, react to the input received from the user with appropriate responses or further questions, and/or the like. Contextual aspects and/or classifications of users, such as identification, segment, product, and/or bandwidth information, etc., may be identified and subsequently analyzed to automatically generate the questions and/or prompts provided to the user. Based on the customer's response to the questions and/or prompts, additional questions and/or prompts may be provided.

Other aspects of the present disclosure may include providing a set of capabilities and/or functionalities to end users, such as administrative users. More particularly, administrators may provide input to one or more “administrative” interfaces, such as a graphical user interface (“GUI”), to access such capabilities and automatically develop, arrange, group, and/or generate the series of questions/prompts provided to the customer. In one example embodiment, the capabilities may be provided as services, such as web services. A service-oriented architecture (“SOA”) may be implemented to provide one or more services that may be accessed by users, such as administrators, to generate, and dynamically update, the questions and/or prompts provided to customers. SOA generally describes the arrangement, coordination, and management of various computers and/or computer functionalities. Each service may implement an event, such as query, read, create and/or update and may be accessible through one or more interfaces, such as a graphical user interface.

The services may be implemented according to a variety of paradigms in their invocation and usage, such as for example, according to a representational state transfer (‘REST”) software paradigm or architecture. A REST architecture abstracts the implementation details of the different architectural elements of a distributed network system, such as servers, clients, gateways, proxies, etc., and provides a standard way for such components to communicate. In particular, the REST architecture involves clients and servers. The clients initiate requests to servers which process the requests and return appropriate responses. A hypertext transfer protocol (“HTTP”) is typically used to initiate the requests and responses between the clients and servers in a REST architecture.

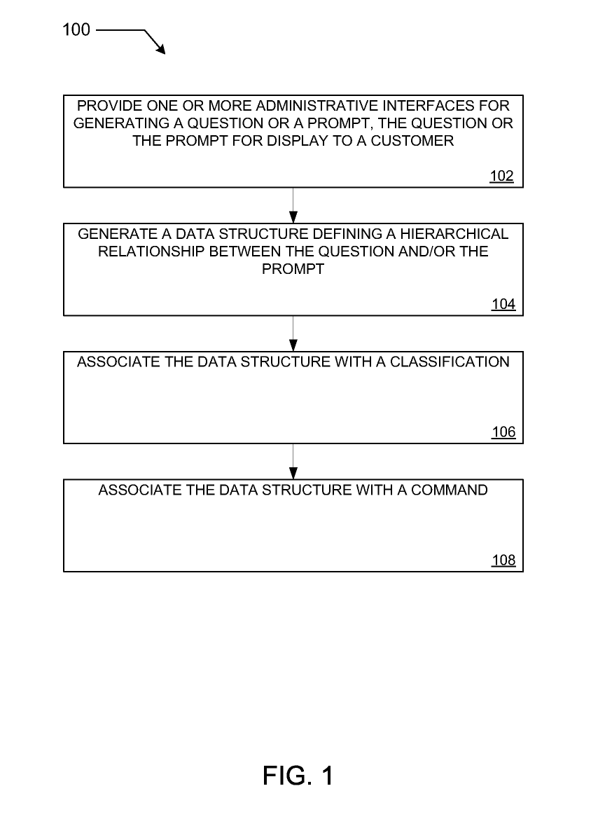

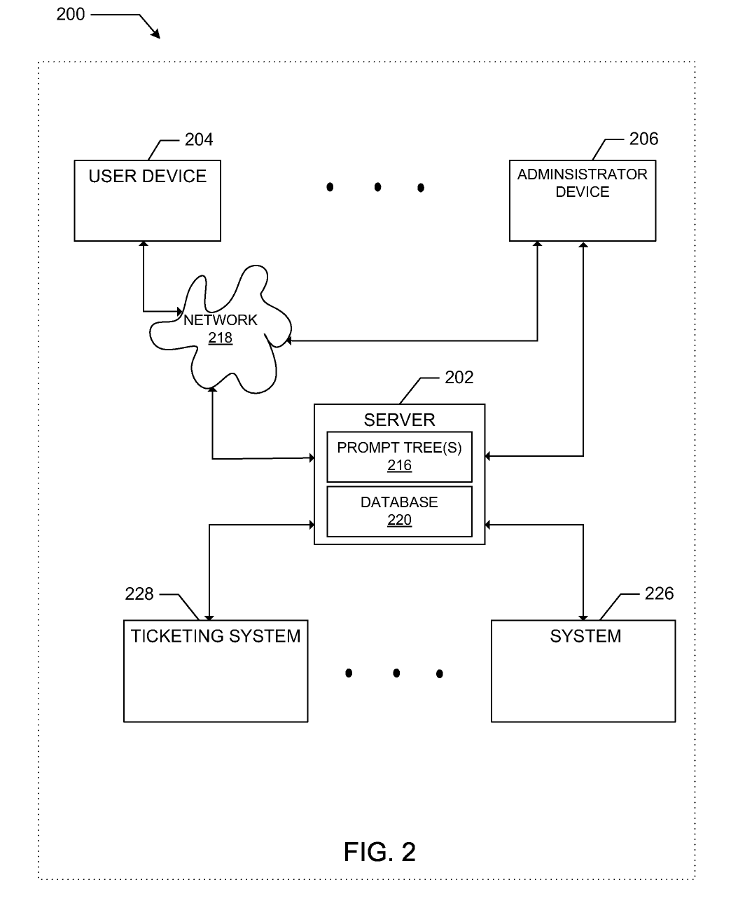

An illustrative process and system for enabling the generation and/or presentation of questions and/or prompts for use in internal and external customer communications and support, such as for example, diagnosing common problems (i.e. customer support), generating customer support tickets, and the like, is depicted in FIGS. 1-2. In particular, FIG. 1 illustrates an example process 100 for providing one or more interactive administrative interfaces capable of generating or displaying questions and/or prompts for subsequent presentation to customers. FIG. 2 illustrates a computing environment 200 including a server 202 configured to generate the one or more administrative interfaces that enable the administrative users to generate any questions and/or prompts. Thus, FIG. 2 illustrates a computing environment 200 including a server 202 operating in conjunction with various other hardware and/or software components (operating on hardware) that may be used to perform or otherwise execute the process 100.

Referring now to FIG. 1, process 100 begins with providing one or more interactive administrative interfaces/input forms (e.g. a user-interface or graphical user-interface (GUI) for generating one or more questions and/or prompts, any of which may be provided for display or presentation to a customer (operation 102). In particular, the server 202 of FIG. 2, provides a mechanism, such as a GUI, where a user may create and define new questions and prompts for a customer. The newly generated questions and/or prompts (or revisions to existing questions and prompts) may subsequently be provided to users, such as customers, to facilitate with solving issues corresponding to current products and/or services, diagnose problems, or submit notifications, and the like. For example, the questions and/or prompts may be related to a new service being provided by the communications provider, customer support issues for existing products and/or services, or may involve additional features or modifications to an existing product or service.

A question is an expression or assertion used to make a request for information. For example, an administrator may provide input to an interface to generate the question, “what is the problem with your service?” A prompt represents a directive or statement describing an action for which the customer should take. For example, an administrator may provide input to an interface to generate the prompt, “please reboot your server.” Through the administrative GUI, the user may thus define a sequence of questions and prompts based on the answer to a particular question. Thus, the administrative interfaces may include various interactive elements, such as buttons, forms, fields, selections, inputs, streams, etc., for receiving input to generate questions, prompts, and/or any combination thereof. In one particular embodiment, the interfaces may include various Hyper Text Markup Language components, such as forms, radio buttons, pop-up dialogs, among others, all of which may be used to generate questions and classify the questions and/or prompts which will be described in detail below.

The administrative interfaces may be generated by the server 202, which may be a personal computer, work station, server, mobile device, mobile phone, processor, and/or other type of processing device and may include one or more processors that process software or other machine-readable instructions. The server 202 may further include a memory to store the software or other machine-readable instructions and data and a communication system to communicate via a wireline and/or wireless communications, such as through the Internet, an intranet, and Ethernet network, a wireline network, a wireless network, and/or another communication network. The server 202 may include a database 220, which is a general repository of data including data, customer data, question data, prompt data, user data, and/or any other data relating to generating interfaces for generating questions and/or prompts. The database 220 may include memory and one or more processors or processing systems to receive, process, query and transmit communications and store and retrieve such data. In another aspect, the database 220 may be a database server.

An administrative user interested in generating one or more questions and/or prompts may interact with an administrator device 206 to initiate a generation request for generating questions and/or prompts, which may be received by the server 202. In response, the server 202 may transmit instructions that may be processed and/or executed to generate, or otherwise display, the various administrative interfaces for generating such questions and/or prompts. The various administrative interfaces may include interactive elements, such as buttons, forms, fields, selections, inputs, streams, etc., for receiving input for generating the questions and/or prompts.

The administrator device 206, may be a personal computer, work station, server, mobile device, mobile phone, tablet device, processor, and/or other processing device capable of implementing and/or executing server processes, software, applications, etc. Additionally, the user device and/or client device 204, 206 may include one or more processors that process software or other machine-readable instructions and may include a memory to store the software or other machine-readable instructions and data. The user device and/or client device 204, 206 may also include a communication system to communicate with the various components of the server 202 via a wireline and/or wireless communications, such as through a network 218, such as the Internet, an intranet, an Ethernet network, a wireline network, a wireless network, a mobile communications network, and/or another communication network. The various administrative interactive interfaces generated in response to a question generation request may be displayed at the user device and/or client device 204, 206.

The various administrative interfaces may be used to structurally organize any generated questions and/or prompts within a hierarchically arranged data structure (operation 104). For example, in one embodiment, the questions and/or prompts may be implemented and/or otherwise represented as a storable data structure (e.g. storable in memory or database), such as a hierarchical tree structure, referred to herein as one or more prompt tree(s) 216. The root (top) level of the prompt tree 216 structure involves a prompt and/or question, which may be expandable to view additional “children” prompts that are expected to be presented to customers. “Children” prompts represent either additional questions/prompts, possible responses to questions/prompts, and/or action(s) (referred to as ‘Commands’). A command represents an action that needs to be implemented, or performed by the system (e.g., the server 202), as will be described in further detail below. For example, a command may set the escalation level of a particular customer's problem. Child questions/prompts, response, etc., may branch off to identify any additional questions/prompts, any possible responses to the questions/prompts, and/or any commands that may be triggered. The prompt tree 216 structure may be continuously modified, enhanced, and/or refined, by redefining the hierarchical relationship of a set of questions and/or prompts using the various interactive components of the administrative interfaces. In one embodiment, the prompt tree may be defined recursively (locally) as a collection of linked nodes (starting at a root node), where each node is a data structure consisting of a value, together with a list of nodes (the “children”), with the constraints that no node is duplicated.

Once a data structure defining the hierarchical relationship of the questions and/or prompts has been defined, the data structure (e.g. a prompt tree) may be associated with and/or otherwise assigned to one or more categorizing traits known as a classification (operation 106). A classification describes whether a particular data structure, for example a particular prompt tree, set of prompts, and/or portion of a prompt tree, etc., should be displayed in certain contexts. Additionally, a classification may describe and/or classify certain capabilities or characteristics of a user, such as a customer. For example, a customer's, segment type, product type, and bandwidth capabilities may be classified. A segment classification classifies the industry and/or type of the customers of business, or the size of the business. The product classification identifies the particular product or service the customer has purchased, and the bandwidth classification quantifies the bandwidth capabilities and/or requirements of the customer. Other classifications may also be included.

In another embodiment, one or more commands may be associated with the generated questions and/or prompts (operation 108). Commands effectively enable the server 202 to perform or otherwise initiate various actions or functions that should be performed by the server 202. For example, a command to create a new troubleshooting ticket may be executed. As another example, a command to set an escalation status may be executed, which automatically sets the escalation status of the current problem or issue for the customer. Other commands may also be associated, some of which include a: Add Notes command, SetStatus Command, SetSeverity Command, CreateTicket Command, etc. The Add Notes command adds information collected from the prompts as a note to a troubleshooting ticket. The Set Status command sets the status of the ticket based the response to a prompt. The Set Severity command sets the severity of a troubleshooting ticket based on a response to a prompt.

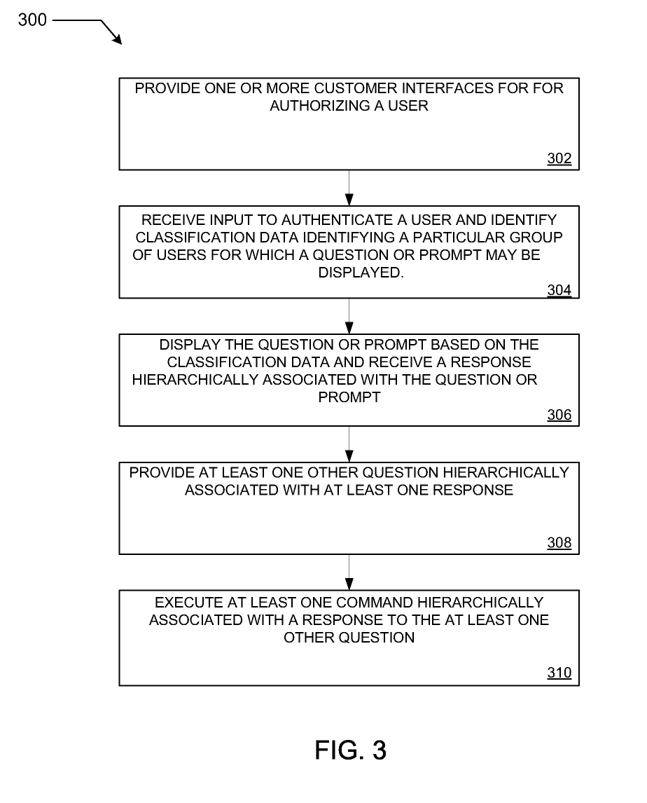

Once one or more questions and/or prompts have been generated by an administrative user, the questions and/or prompts may be used to guide users, such as customers, through such questions and/or prompts when attempting to solve technical issues, diagnose problems with existing product and/or services, submit notifications, and the like. For example, in one particular embodiment, the questions and/or prompts may be presented and/or otherwise displayed on various “customer” interfaces generated by the server 202 that may be used to allow customers engage in a dynamic dialog, such as for example, during a customer support interaction, during the ordering of a product and/or service, etc. FIG. 3 depicts an example embodiment of a method and/or process 300 for displaying one or more questions/prompts to a customer, which may be performed by the various hardware components of FIG. 2.

As illustrated in FIG. 3, initially, one or more customer interfaces may be provided that include various components capable of receiving authorization input from a customer (operation 302). In one particular embodiment, a customer, interested in interacting with one or more of the generated questions and/or prompts, such as for example, while engaging in a customer service dialog, may interact with a user device 204 to initiate a customer request, which may be received by the server 202. In response, the server 202 may transmit instructions that may be processed and/or executed to generate, or otherwise display, the various customer interfaces for receiving input corresponding to the displayed questions and/or prompts. In one embodiment, a login form may be displayed, and in response, a user, such as a customer, may provide user authentication data (e.g. a user identification and a corresponding password). In any embodiment, the various customer interfaces may include interactive elements, such as buttons, forms, fields, selections, inputs, streams, etc., for receiving input corresponding to the questions and/or prompts. The user device 204, may be a personal computer, work station, server, mobile device, mobile phone, tablet device, processor, and/or other processing device capable of implementing and/or executing server processes, software, applications, etc., and may include the same or similar components of the administrative device 206 as described above.

Any input received may be processed and used to identify a particular user and any corresponding classification data corresponding to the user (operation 304). In particular, the classification data may be identify a particular group of users for which at least one question may be displayed. For example, the server 202 may parse and/or otherwise process the user authentication data to identify a valid customer and corresponding classification data. User authentication data includes any information that may be used to identify a particular user, such as name, customer contact information, unique identifier (e.g. number, code), business type, etc. The server 202 may process the user authentication data to identify that the customer is in the Healthcare segment, is purchasing IP VPN products, and requires DS1 bandwidth capabilities. In one embodiment, the server 202 may query a database based on the user authentication data to access stored classification data.

One or more questions and/or prompts within the prompt tree 216 may be identified and subsequently provided for display based on the classification data and a hierarchically associated response to the question/prompt may be received from the user (operation 306). For example, a question asking “What is the problem with your service?” may be generated, and a user may provide a response indicating a problem with a network device. As another example, a prompt stating, “Please determine the color of the blinking LED on your unit” may be generated, and a user may provide a response, such as by selecting a radial button adjacent the various possible responses, indicating that the LED light color is yellow by selecting the specific radial button associated with yellow.

Optionally, another question and/or prompt that is hierarchically associated with the response may be provided to the user based on the user response to the previous question (operation 308). For example, if a customer responded “No,” to the question “have you validated that your equipment is working properly?,” the prompt, “we have submitted a service ticket per your request Click Ok to continue.” may be displayed to the customer. “It is contemplated that any number of questions may be identified to which any number of hierarchically associated questions may be provided.

As another example, a question corresponding to the customer's health care segment (i.e. classification data) may be identified, such as “has the equipment outage impacted patient care?” and the answer is “yes,” the system (e.g. the server 202) may be customized to cause an immediate escalation. For example, here, within the segment of healthcare, a trouble ticket that is associated with patient care may be handled differently from trouble tickets that do not involve patient care. So, for example, in normal circumstances, the ticket may cause a technician to phone the healthcare client's IT person within one hour in order to begin resolving the concern whereas a problem concerning patient care may invoke the immediate establishment of a bridge between a senior technology person and the client's IT person so that the problem can be resolved quickly.

A hierarchically associated command may be executed based on the user response to the other question (operation 310). For example, a command to initiate a test application may be executed. For example, a user may be presented with the prompt “Would you like us to run a test on your service?”. If the user provides a response in the form of “Yes” then a test application may automatically be executed. If the user provides a response that is “No” then a different question and/or prompt may be provided.

In one embodiment, the commands may be executed to initiate one or more functions of systems 226-228, such as for example, the ticketing system 228. For example, the ticketing system (or other system) may be automatically initiated using a command to send a customer an invoice via email, subscribe a customer to receive scheduled maintenance notifications, disconnect a customer's service, upgrade a customer's service, transmit service performance metrics to a customer, etc.

The ticket system 228 may include ticket information and/or data, such as for example, one or more trouble tickets corresponding to a particular customer, and one or more processors for executing instructions and/or processes related to the management and processing of trouble tickets. For example, a trouble ticket may explain a current issue a particular customer is facing and the steps being taken to solve the issue. The ticket system 228 may interact and communicate directly, or indirectly (e.g. via communication network 218) with the server 202 and may be located external to the server 202, or elsewhere, and may include or otherwise communicate with various other external trouble ticketing services.

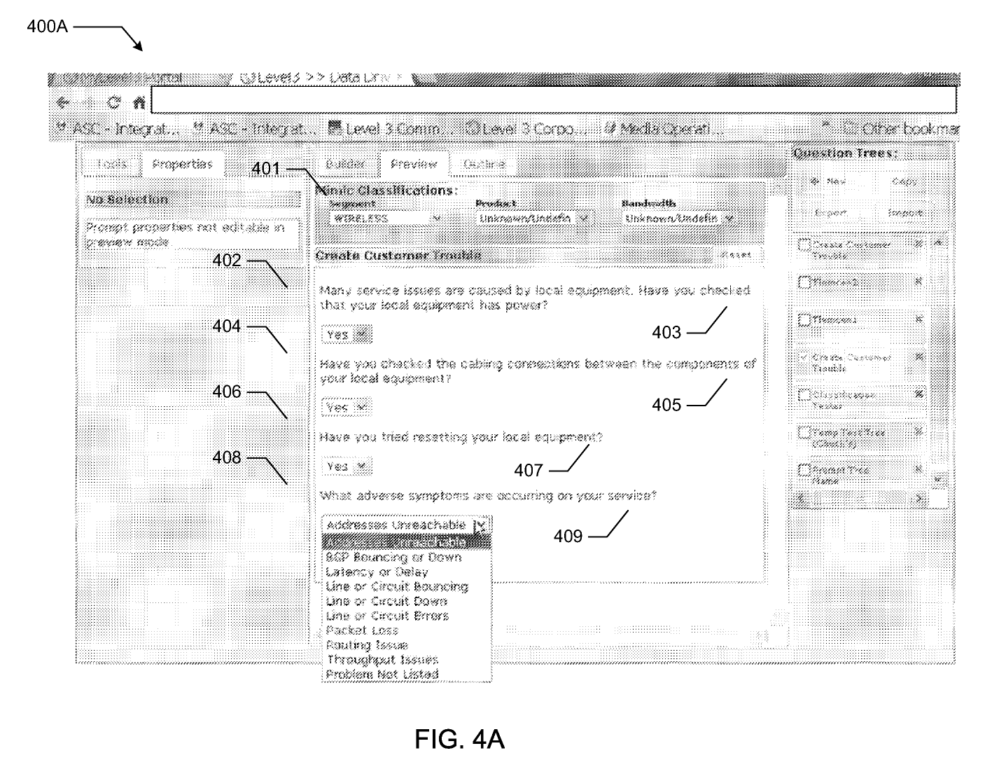

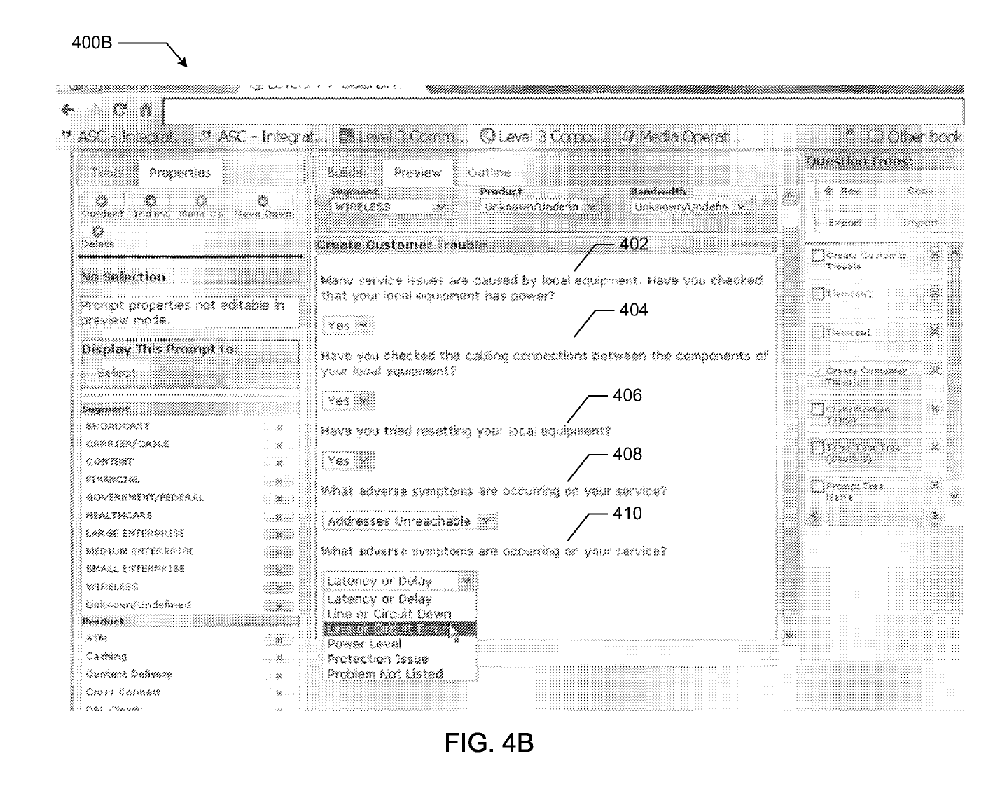

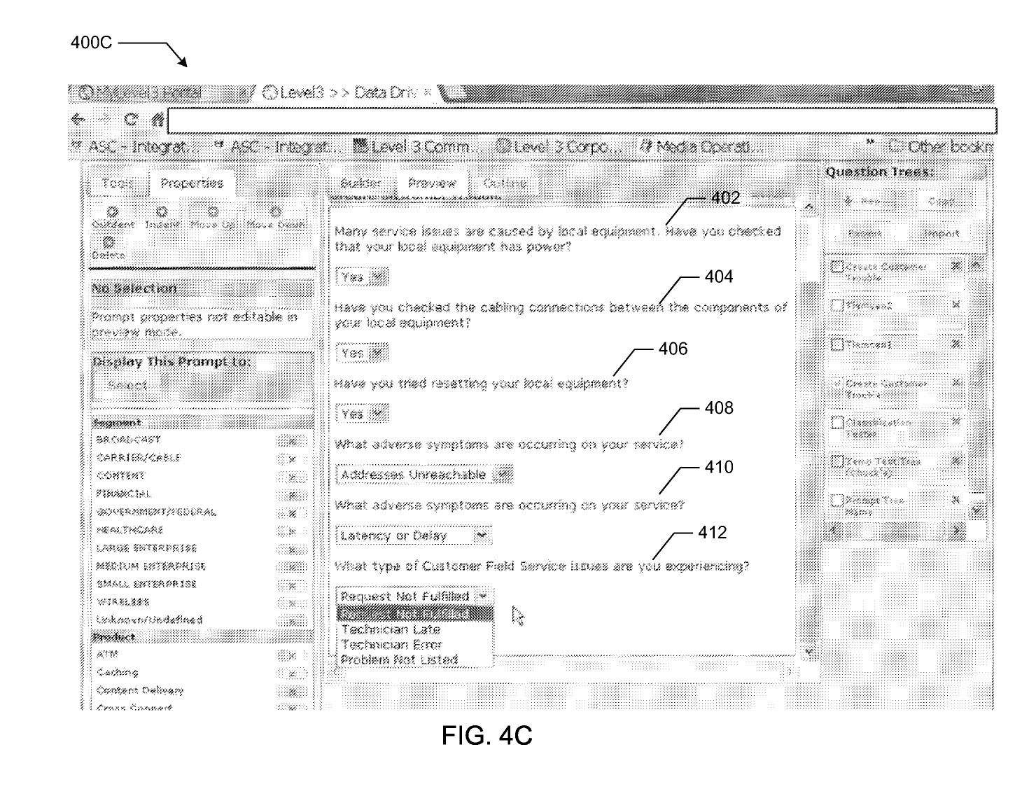

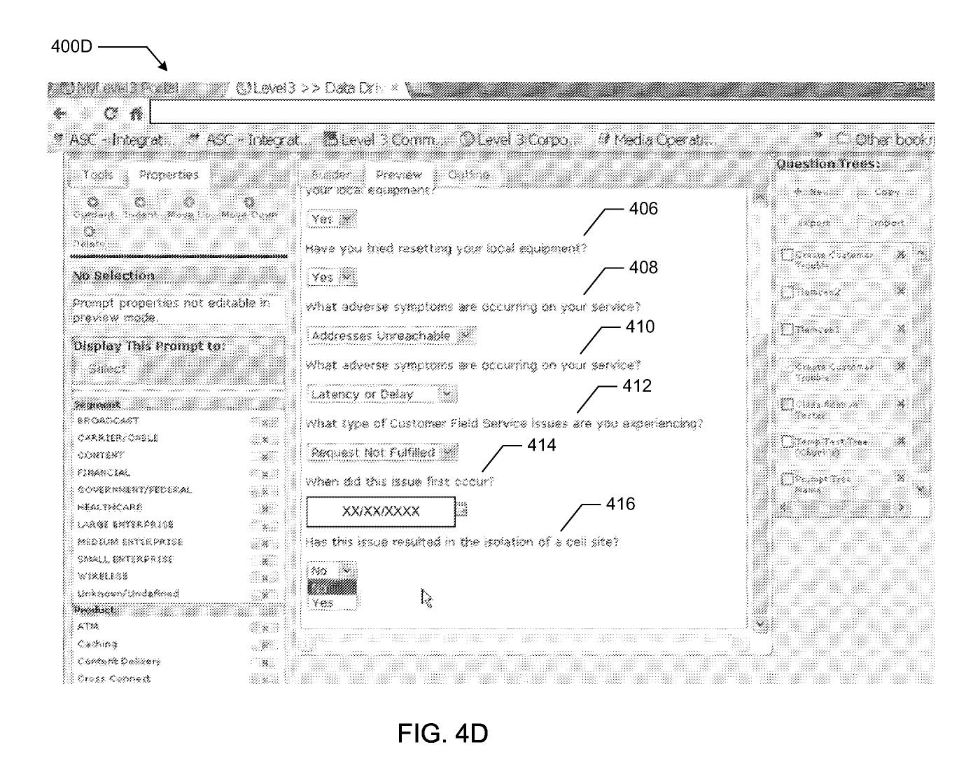

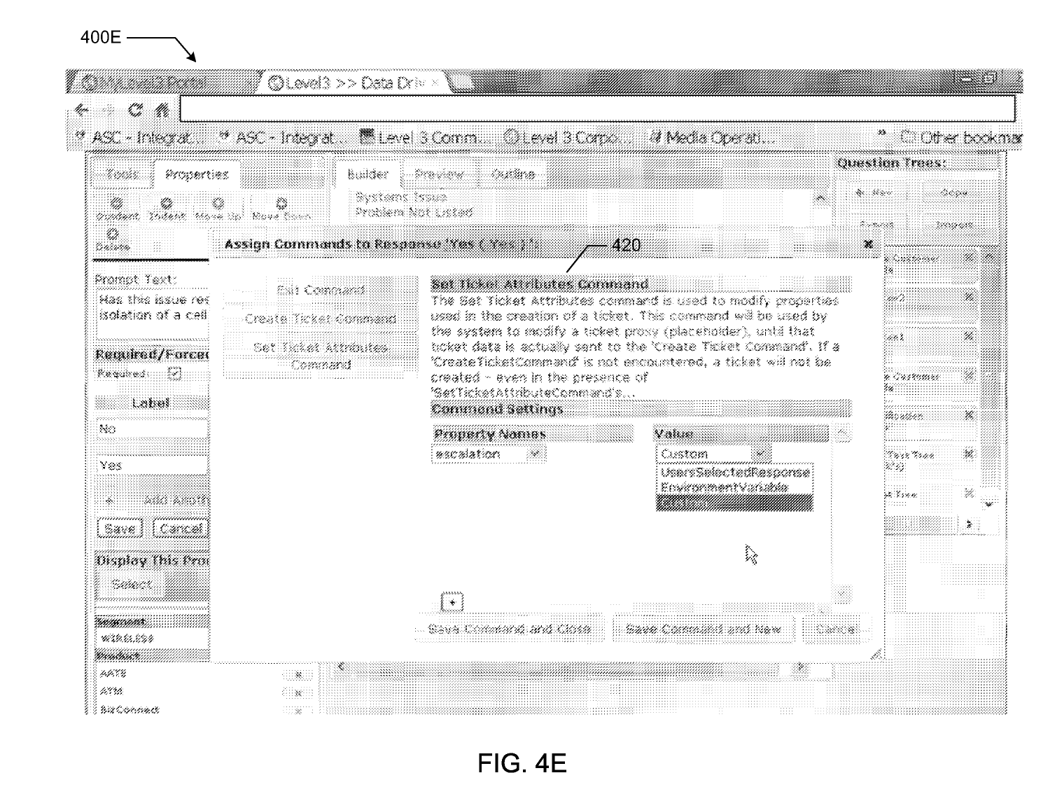

An illustrative example for generating one or more questions and/or prompts to be provided to users will now be provided. In particular, FIGS. 4A-4E illustrate a sequence of screen shots related to an example sequence of questions or prompts being generated based upon a segment classification. The illustrated questions: 402, 404, 406, and 408 are from a administrative interface referred to as a preview pane 400 used to view the question sequence as it is being defined (e.g. questions 402, 404, 406, and 408 and responses 403, 405, 407, and 409) and prior to making the questions available to a customer. Thus, for example, the first question 402 asks “. . . Have you checked that your local equipment has power?” and the selection of “yes” as a response 403 in the drop down menu elicits the following question of “Have you checked the cabling connections . . . ” 404 and so on, as shown in FIGS. 4A-4C. The sequence of questions and/or prompts are customized for a particular segment, in this example the “wireless” segment 401.

At FIG. 4D, there is a question of “Has this issue resulted in the isolation of a cell site?” 416. For a customer in the wireless space, the isolation of a cell site directly impacts the customer's business and should be treated differently than those issues that do not directly impact the customer's business. Thus, a user has the ability to tailor service responses at a very granular level and therefore can invoke a response that is tailored and appropriate for a particular customer. Because the various processes of the server 202 can be tailored to drive the customer specific response while also addresses other specific customer issues, such as industry segment, product and bandwidth, the tailored service response is possible without a call center technician and/or irrespective of the call center technicians familiarity with the client, the client's industry segment, the product, the bandwidth, and/or other customizable aspects to the system.

FIG. 4E illustrates a GUI that can be used to customize and/or otherwise associated a command 420 to a particular response based on the answer to the question. As illustrated, if the answer is yes, the user can associate a command to question response, and further, “escalate” the response. Referring again to FIG. 4D, the question may also have child questions such as “Does the cell isolation also cause market isolation” 416. Moreover, additional tiers of response, such as additional tiers of escalation, depending upon the answers to the questions may be configured. So, for example, cell isolation may result in an immediate bridge being established with the customer to resolve the issue. An entire market isolation may not invoke an immediate bridge but may also involve additional responses, such as immediate responses by senior technicians, direct customer contact at different levels of management, as cell isolation, while problematic, is not as problematic as market isolation. Thus, the system is extensible to current and future customers of a business and may be customizable to the customer's specific needs.

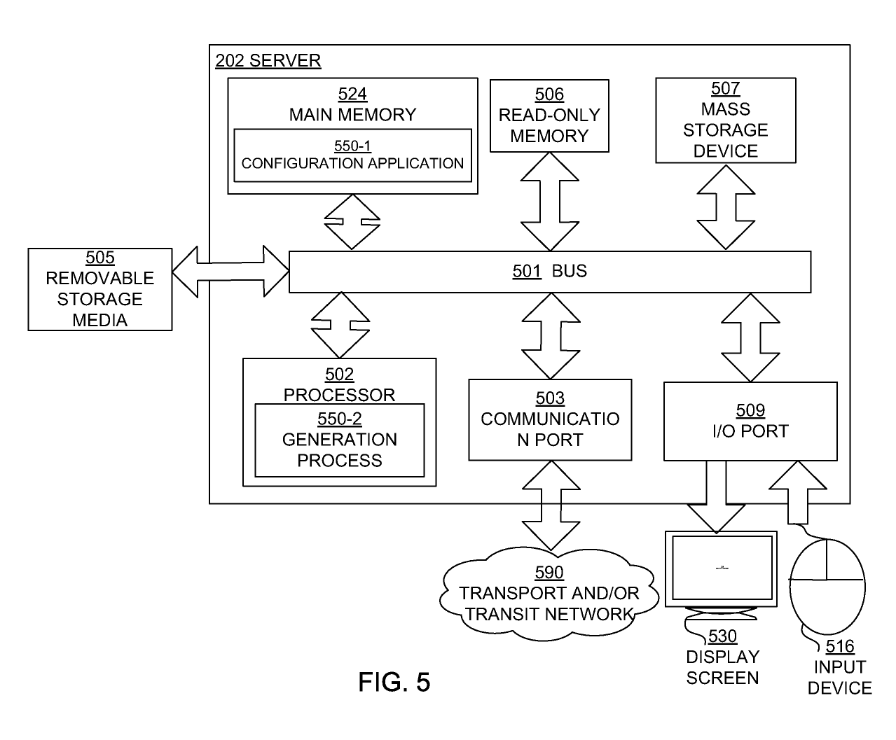

FIG. 5 is example schematic diagram of a computing system implementing an server 202 that may be use to generate questions and/or prompts, according to one embodiment. The computing system for the server 202 includes a bus 501 (i.e., interconnect), at least one processor 502, at least one communication port 503, a main memory 504, a removable storage media 505, a read-only memory 506, and a mass storage device 507. Processor(s) 502 can be any known processor, such as, but not limited to, an Intel® Itanium® or Itanium 2® processor(s), AMD® Opteron® or Athlon MP® processor(s), or Motorola® lines of processors. Communication port 503 can be any of an RS-232 port for use with a modem based dial-up connection, a 10/100 Ethernet port, a Gigabit port using copper or fiber, or a USB port. Communication port(s) 503 may be chosen depending on a network such as a Local Area Network (LAN), a Wide Area Network (WAN), or any network to which the computer system 100 connects. The server 202 may be in communication with peripheral devices (e.g., display screen 530, input device 516 via Input/Output (I/O) port 509.

Main memory 504 can be Random Access Memory (RAM) or any other dynamic storage device(s) commonly known in the art. Read-only memory 506 can be any static storage device(s) such as Programmable Read-Only Memory (PROM) chips for storing static information such as instructions for processor 502. Mass storage device 507 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices, may be used.

Bus 501 communicatively couples processor(s) 502 with the other memory, storage and communications blocks. Bus 501 can be a PCI/PCI-X, SCSI, or Universal Serial Bus (USB) based system bus (or other) depending on the storage devices used. Removable storage media 505 can be any kind of external hard drives, floppy drives, IOMEGA® Zip Drives, Compact Disc—Read Only Memory (CD-ROM), Compact Disc—Re-Writable (CD-RW), Digital Video Disk—Read Only Memory (DVD-ROM), etc.

Embodiments herein may be provided as a computer program product, which may include a machine-readable medium having stored thereon instructions which may be used to program a computer (or other electronic devices) to perform a process. The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

As shown, main memory 504 is encoded with the generation application 550-1 that supports functionality as discussed above and as discussed further below. For example, in one embodiment, the generation application 550-1 may include or otherwise implement the various processes and/or instructions described herein. The generation application 550-1 (and/or other resources as described herein) can be embodied as software code such as data and/or logic instructions (e.g., code stored in the memory or on another computer readable medium such as a disk) that supports processing functionality according to different embodiments described herein. During operation of one embodiment, processor(s) 502 accesses main memory 504 via the use of bus 501 in order to launch, run, execute, interpret or otherwise perform the logic instructions of the generation application 550-1. Execution of the generation application 550-1 produces processing functionality in generation process 550-2. In other words, the ordering process 550-2 represents one or more portions of the ordering application 550-1 performing within or upon the processor(s) 202 in the computer system 500.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages should be understood by the foregoing description, and it should be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it should be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for generating questions comprising:
generate, using at least one processor, a plurality of services to:
authenticate a user to obtain classification data, the classification data identifying a group of users for which at least one question may be displayed, the question stored in a data structure defining a hierarchical relationship between the question, a response, and at least one other question; and
provide the at least one question to at least one user of the group of users for display.

2. The method of claim 1, wherein accessing at least one of the plurality of services further comprises:
receiving the response for the question; and
as a result of receiving the response, provide the at least one other question to the user, the at least one other question hierarchically associated with at least one command, the at least one command to automatically initiate the generation of a trouble ticket corresponding to the user.

3. The method of claim 2, wherein accessing at least one of the services further comprises:
receiving another response for the at least one other question; and
executing the at least one command based on the other response.

4. The method of claim 1, wherein the at least one question and the at least one other question are hierarchically maintained within a prompt tree data structure comprising a collection of nodes, at least one node of the collection of nodes being a root node containing the at least one question and a list of nodes, at least one node of the list of nodes containing the at least one other question.

5. The method of claim 2, further comprising generating one or more interfaces for displaying the at least one question, receiving the response, and displaying the at least one other question.

6. The method of claim 1, wherein the classification data comprises a segment classification describing an industry in which the user belongs.

7. The method of claim 1, wherein the plurality of services conform to a representational state transfer resource architecture and are accessible using standard hypertext transfer protocol-accessible mechanisms.

8. A system for generating questions comprising:
at least one processor to:
generate a plurality of services to:
authenticate a user to obtain classification data, the classification data identifying a group of users for which at least one question may be displayed, the question stored in a data structure defining a hierarchical relationship between the question, a response, and at least one other question; and
provide the at least one question to at least one user of the group of users for display.

9. The system of claim 8, wherein to access at least one of the plurality of services further comprises:
receiving the response for the question; and
as a result of receiving the response, provide the at least one other question to the user, the at least one other question hierarchically associated with at least one command, the at least one command to automatically initiate the generation of a trouble ticket corresponding to the user.

10. The system of claim 9, wherein accessing at least one of the services further comprises:
receiving another response for the at least one other question; and
executing the at least one command based on the other response.

11. The system of claim 8, wherein the at least one question and the at least one other question are hierarchically maintained within a prompt tree data structure comprising a collection of nodes, at least one node of the collection of nodes being a root node containing the at least one question and a list of nodes, at least one node of the list of nodes containing the at least one other question.

12. The system of claim 9, wherein the at least one processor is further configured to generate one or more interfaces for displaying the at least one question, receiving the response, and displaying the at least one other question.

13. The system of claim 8, wherein the classification data comprises a segment classification describing an industry in which the user belongs.

14. The system of claim 8, wherein the plurality of services conform to a representational state transfer resource architecture and are accessible using standard hypertext transfer protocol-accessible mechanisms.

15. A non-transitory computer readable medium encoded with instructions for generating and presenting questions, the instructions, executable by a processor, comprising:
generate a plurality of services to:
authenticate a user to obtain classification data, the classification data identifying a group of users for which at least one question may be displayed, the question stored in a data structure defining a hierarchical relationship between the question, a response, and at least one other question; and
provide the at least one question to at least one user of the group of users for display.

16. The non-transitory computer readable medium of claim 15, wherein accessing at least one of the plurality of services further comprises:
receiving the response for the question; and
as a result of receiving the response, provide the at least one other question to the user, the at least one other question hierarchically associated with at least one command, the at least one command to automatically initiate the generation of a trouble ticket corresponding to the user.

17. The non-transitory computer readable medium of claim 16, wherein accessing at least one of the services further comprises:
receiving another response for the at least one other question; and
executing the at least one command based on the other response.

18. The non-transitory computer readable medium of claim 15, wherein the at least one question and the at least one other question are hierarchically maintained within a prompt tree data structure comprising a collection of nodes, at least one node of the collection of nodes being a root node containing the at least one question and a list of nodes, at least one node of the list of nodes containing the at least one other question.

19. The non-transitory computer readable medium of claim 16, further comprising generating one or more interfaces for displaying the at least one question, receiving the response, and displaying the at least one other question.

20. The non-transitory computer readable medium of claim 15, wherein the classification data comprises a segment classification describing an industry in which the user belongs.

21. The non-transitory computer readable medium of claim 15, wherein the plurality of services conform to a representational state transfer resource architecture and are accessible using standard hypertext transfer protocol-accessible mechanisms.
